(19) United States
(12) Patent Application Publication
(10) Pub. No.: US 2011/0011087 A1
(43) Pub. Date: Jan. 20, 2011

(54) SOLAR COLLECTOR AND ENERGY CONVERSION SYSTEMS AND METHODS

(76) Inventor: Jens Ole Sorensen, Rancho Santa Fe, CA (US)

Correspondence Address: EDWARD W CALLAN, NO. 705 PMB 452, 3830 VALLEY CENTRE DRIVE, SAN DIEGO, CA, 92130, US

(21) Appl. No.: 12/667,682

(22) PCT Filed: Jul. 7, 2008
(86) PCT No.: PCT/US08/08356

§ 371 Date: Jan. 4, 2010

Related U.S. Application Data
(60) Provisional application No. 60/948,146, filed on Jul. 5, 2007.

(51) Int. Cl. F03G 6/00; B23P 15/26; F24J 2/00; F24J 2/34; F24J 2/40

(52) U.S. Cl. 60/641.8; 29/890.033; 126/714; 126/620; 126/584

(57) ABSTRACT

A solar collector system includes sheets that are disposed to cover portions of channels within a terrain to thereby form air flow passageways bounded by at least the sheet and the sides and bottom of the respective channels. The sheet enables transmission of solar radiation into the channels to heat portions of the sides and bottoms of the channels so that air in the passageways can be heated by absorbing heat from the heated portions of the sides and bottoms of the channels. A heat accumulation system is coupled to the passageways for accumulating heat from the heated air. A stream of heated air is drawn from the solar collector and/or the heat accumulation system by an upwardly sloping tunnel through a turbine of an electrical energy producing system. The air stream rotates the turbine to cause electrical energy to be generated.

### CROSS-REFERENCE TO RELATED APPLICATION

This is a continuation-in-part of U.S. provisional patent application No. 60/948,146 filed Jul. 5, 2007.

### BACKGROUND OF THE INVENTION

The present invention generally pertains to solar collector and energy conversion systems and methods and to improvements to the type solar collection system in which air is heated by absorbing heat from materials that are heated by solar radiation and flows into a rising conduit for production of electrical energy.

In one such solar collector system, which is described in U.S. Pat. No. 3,436,908, air within an upwardly extending hollow tube is heated by absorbing heat from heat-conductive materials surrounding the tube that are heated by solar radiation. The heated air within the tube expands and becomes lighter, and is displaced by atmospheric air through the bottom of the tube, thus creating air flow through the tube. Said patent suggests using the stream of air heated by the solar collector to produce electrical energy.

### SUMMARY OF THE INVENTION

The present invention provides a solar collector system, comprising: at least one sheet that is disposed to cover at least a portion of at least one channel within a terrain to thereby form an air flow passageway bounded by at least the sheet and the sides and bottom of the channel, wherein the sheet enables transmission of at least some solar radiation into the channel so that at least portions of the sides and bottom of the channel can be heated by the transmitted solar radiation so that air in the passageway can be heated by absorbing heat from at least the heated portions of the sides and bottom of the channel; and means for enabling a stream of heated air to flow from the passageway.

The present invention also provides a heat accumulation system for accumulating heat from a heated stream of air from a solar collector, comprising: a heat transfer medium for accumulating heat from the heated air stream; and means for conducting a stream of heated air from the heat transfer medium.

The present invention further provides a method of constructing a solar collector system, comprising the steps of:

(a) constructing at least one channel within a terrain;

(b) covering at least a portion of the at least one channel with at least one sheet to form an air flow passageway bounded by at least the sheet and the sides and bottom of the channel, wherein the sheet enables transmission of at least some solar radiation into the channel so that at least portions of the sides and bottom of the channel can be heated by the transmitted solar radiation so that air in the passageway can be heated by absorbing heat from the heated portions of the sides and bottom of the channel; and

(c) coupling to the passageway to means for enabling a stream of heated air to flow from the passageway.

The present invention still further provides a method of deriving energy from solar radiation, comprising the steps of:

(a) enabling solar radiation to be transmitted through at least one sheet into an air flow passageway bounded by the sheet and at least one channel within a terrain, wherein at least a portion of the channel is covered by the at least one sheet so that at least portions of the sides and bottom of the channel can be heated by the transmitted solar radiation so that air in the passageway can be heated by absorbing heat from the heated portions of the sides and bottom of the channel; and

(b) enabling air to flow through the passageway and thereby be heated by absorbing heat from heated portions of the sides and bottom of the channel; and

(c) enabling a stream of heated air to flow from the passageway.

The present invention additionally provides a method of utilizing a sloping tunnel to facilitate conversion of solar radiation to electrical energy, comprising the steps of:

(a) heating a stream of air with a solar collector;

(b) conducting the stream of heated air to a turbine that is coupled to an electricity generator in an electrical energy producing system for generating electricity when the turbine is rotated; and

(c) conducting the stream of heated air through the turbine with a sloping tunnel system that is disposed inside and/or outside of a high rise of terrain and extends from a first elevation to a second elevation that is of a higher elevation than the first elevation, to thereby rotate the turbine and cause electricity to be generated;

wherein a significant portion of the tunnel system leads in a direction that is non-orthogonal to vertical and horizontal.

Additional features of the present invention are described with reference to the detailed description of the preferred embodiments.

### BRIEF DESCRIPTION OF THE DRAWING

The drawing figures herein are not drawn to scale.

FIG. 1 is a schematic partial top view of an exemplary solar collector according to this invention.

FIG. 2 is a partial sectional side view of the solar collector taken along section line 2-2 in FIG. 1.

FIG. 3 illustrates an enlargement of a sheet anchoring device shown in FIG. 2.

FIG. 4 illustrates an alternative embodiment using the sheet anchoring device shown in FIG. 3.

FIG. 5 is a schematic diagram of air pressure control system for use in the solar collector system of FIG. 1.

FIG. 6 is a schematic partial view of an exemplary embodiment of an energy conversion system that includes a solar collector system according to the present invention in combination with a system for producing electrical energy and a heat accumulation system.

FIG. 7 is a partial sectional top view of one embodiment of a heat accumulation system according to the present invention.

FIG. 8 is a partial sectional top view of another embodiment of heat accumulation system according to the present invention.

FIG. 9 is a partial sectional side view taken along the section line 9-9 of FIG. 8.

FIG. 10 is a partial sectional top view of still another embodiment of heat accumulation system according to the present invention.

FIG. 11 is a partial sectional side view taken along the section line 11-11 of FIG. 10.

### DETAILED DESCRIPTION

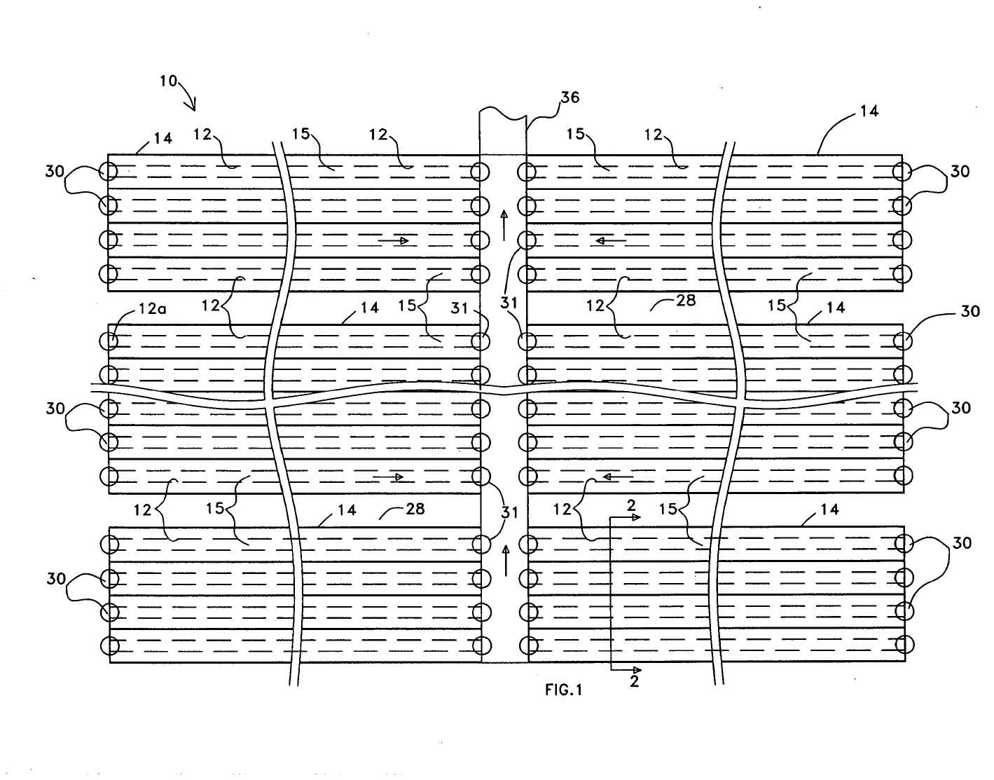

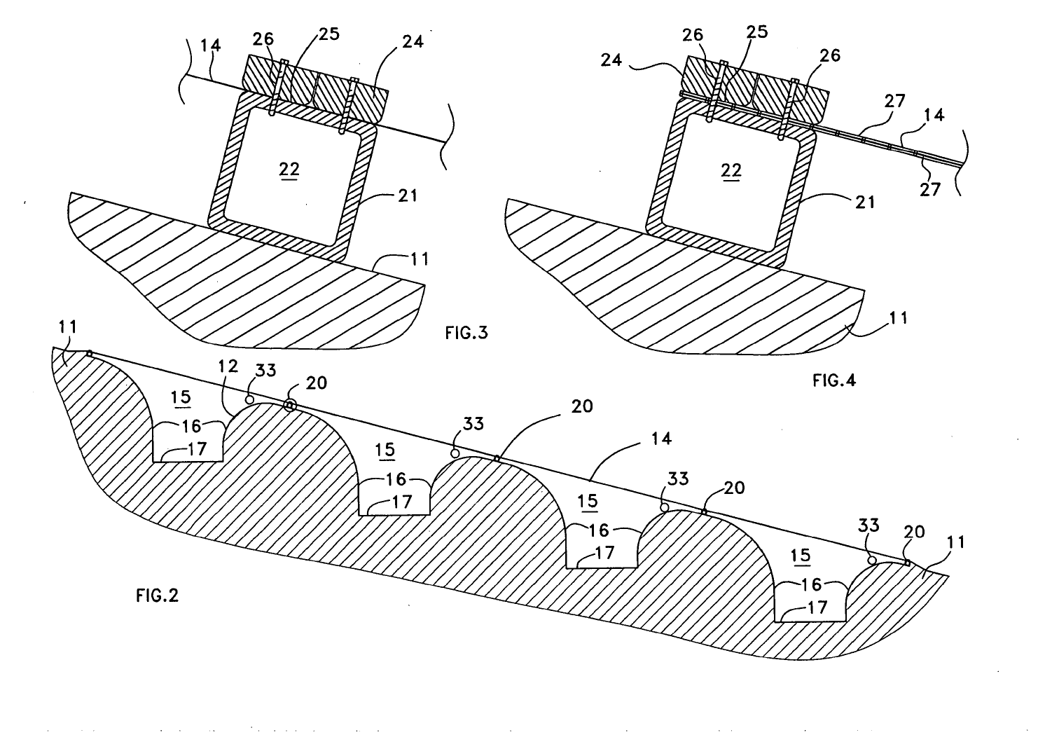

Referring to FIGS. 1 and 2, an exemplary embodiment of a solar collector system 10 according to the present invention is adapted for installation in and over a sloping terrain 11. A south-facing sloping terrain enables more efficient collection of solar radiation. However, too much slope has the disadvantages of accelerated erosion with damage to the solar collection system. A slope of about fifteen degrees is preferred. In other embodiments, the slope is to some other degree, or the terrain 11 is relatively flat and/or partially sloping at various degrees.

The solar collector 10 is constructed by constructing a plurality of channels 12 in the terrain 11 and covering at least portions of the respective channels 12 with a plurality of sheets 14 to form a plurality of air flow passageways 15. The channels 12 substantially follow equal-elevational contours of the terrain 11.

Each passageway 15 is bounded by at least the sheet 14 covering an individual channel 12 and the sides 16 and bottom 17 of the individual channel 12. One or more materials that absorb solar radiation as heat are included in the bottom 17 and/or one or both sides 16 of each channel 12. In another embodiment no accessory materials are supplied.

Each sheet 14 enables transmission of at least some solar radiation into the channels 12 so that at least portions of the sides 16 and the bottoms 17 of the channels 12 can be heated by the transmitted solar radiation so that air in the passageways 15 can be heated by absorbing heat from the heated portions of the sides 16 and the bottoms 17 of the channels 12. Each sheet 14 is transparent or translucent.

Preferably, each sheet 14 is flexible. An exemplary flexible sheet 14 is a plastic film. In some alternative embodiments, some sheets 14 are rigid, or some sheets 14 are a combination of flexible and rigid.

An individual sheet 12 is anchored to elevated portions of the terrain 11 by a plurality of devices 20. Referring to FIGS, 3 and 4, the sheet anchoring device 20 includes plastic pipes or pipe sections 21 that are filled with sand and/or gravel 22. Preferably the pipes 21 are made of UV stabilized black polyethylene, polypropylene or PVC. The pipes 21 may be made in sections having ends that are closed after the pipes 21 have been filled with the sand or gravel 22. For example, the pipes 21 may have an outside dimension of eight-by-eight inches; and two-inch-by-four-inch boards 24 are used to hold the sheet 14 in place. Caulking or glue 25 is applied between the boards 24 and the sheet 14 and also between the pipes 21 and the sheet 14. Screws 26 are used to tighten the device 20.

FIG. 4 shows an alternative embodiment in which the sheet anchoring device 20 is combined with a mesh 27 when the sheet 14 is flexible. The mesh 27 covers and/or underlies the flexible sheet 14 to partially support the flexible sheet 14. The mesh 26 may be wire or a plastic fiber inside or attached to the flexible sheet 14.

An individual sheet 14 may for example be 30-feet wide and 300-feet long. A vehicle may drive inside the channels 12 beneath the sheets 14 for maintenance. A maintenance vehicle access road 28 is provided between the sheets 14 that cover four sets of passageways 15. The maintenance vehicle can be equipped with a hydraulic crane and a man-sized basket for enabling overhead access to the sheets 14. Vacuum cleaners, blowers and water spray can be used to remove dust from the sheets 14.

An air intake gate 30 is disposed at an inlet to the passageway 15 for controlling the flow of air into the passageway 15; and a variably controlled air output gate 31 is disposed at an outlet from the passageway 15 for controlling the flow of air from the passageway.

An individual flexible sheet 14 is partially supported by air pressure within the underlying passageways 15.

Because of the sloping terrain 14 the pressure of the air heated within an individual air passage 15 may vary to such an extent as to cause portions of the sheets 14 to explode or implode, especially when the sheet 14 is a flexible plastic film. In order to prevent extreme variations in the air pressure within the passageway 15 that may result in such an explosion, an air pressure control system is provided. Referring to FIG. 5, the air pressure control system includes one or more air pressure measurement devices 33 disposed in each of the passageways 15 and a gate controller 34.

The air pressure measurement devices 33 are disposed near the sheet 14 over elevated terrain 11 so that such devices are not interfered with by a vehicle moving within the channel 12. The air pressure measurement devices 33 are used for continuously measuring the air pressures at various locations within the passageway 15.

The gate controller 34 is responsive to the air pressure measurements for operating one or both of the gates 30, 31 to control the flow of air into and/or from the passageway 15 and thereby regulate the air pressure within the passageway 15. The amount of opening and closing of the individual gates 30, 31 is determined, dampened and delayed to prevent over reaction, oscillations etc.

A plurality of passageways 15 are coupled to a conduit 36. The conduit 36 collects streams of heated air flowing from the plurality of passageway 15.

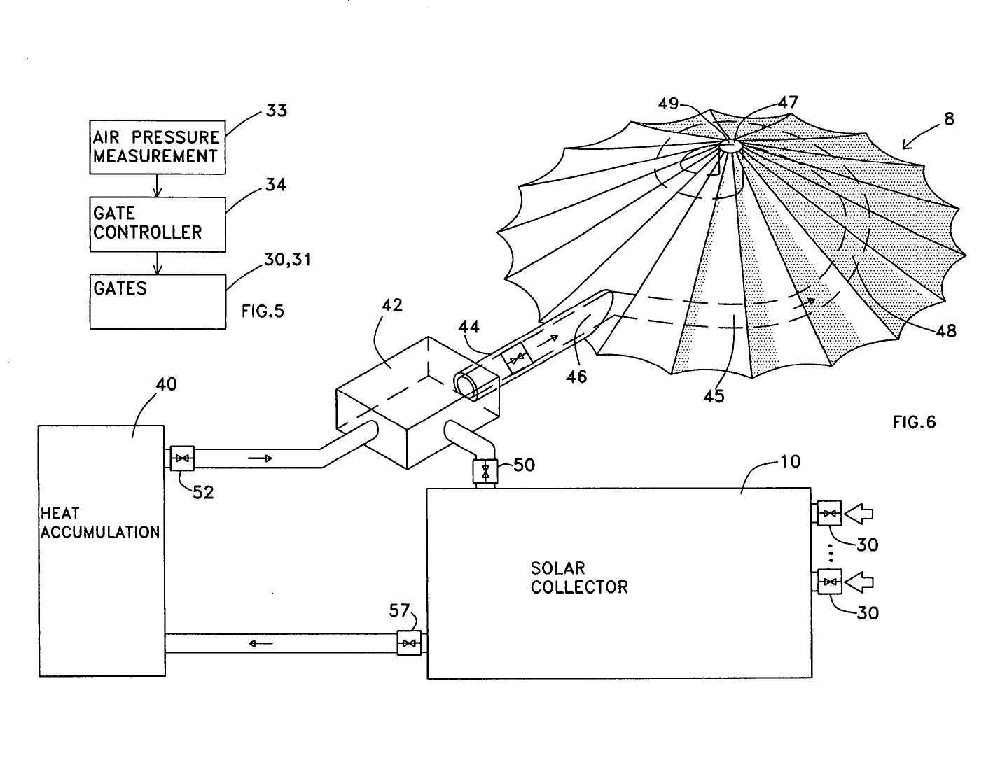

Referring to FIG. 6, an exemplary embodiment of an energy conversion system includes a solar collector system 10 according to the present invention in combination with a heat accumulation system 40 and a system 42 for producing electrical energy from a stream of heated air. Alternatively to the location shown in FIG. 6, the heat accumulation system 40 may conveniently be placed under the solar collector 10.

The heat accumulation system 40 is coupled to the passageways 15 of the solar collector 10 for accumulating heat at various times from a heated stream of air that collected by the conduit 36. The heat accumulation system 40 includes a heat transfer medium for accumulating heat from the heated air stream and means for conducting a stream of heated air from the heat transfer medium to the electrical energy producing system 42.

A stream of heated air is conducted to the electrical energy producing system 42 from the solar collector 10 and/or the heat accumulation system 40 in accordance with how much heat is being provided by the stream of heated air that is flowing from the solar collector 10.

The electrical energy producing system 42 includes a turbine (not shown) and an electricity generator (not shown) coupled to the turbine for generating electricity in response to rotation of the blades of the turbine. The stream of heated air that is conducted to the electrical energy producing system 42 flows through the turbine to rotate the blades of the turbine and thereby cause the electricity generator to generate electricity.

This exemplary embodiment of an energy conversion system utilizes a conduit 44 that extends from the turbine into a sloping tunnel system 45 that is constructed inside and/or on the outside of a high rise of terrain, such as a mountain, to draw the stream of heated air through the turbine. The tunnel system 45 extends from a first elevation 46 to a second elevation 47 that is of a higher elevation than the first elevation 46. A significant section 48 of the tunnel system 45 leads in a direction that is non-orthogonal to vertical and horizontal. In one exemplary embodiment, the tunnel system 45 has an upward slope in the order of thirty degrees from horizontal; the change in elevation is on the order of one-to-two kilometers; and the length of the tunnel system 45 is on the order of two-two-four kilometers.

Conversion of solar radiation to electric power takes place in the energy conversion system of FIG. 6 as follows. Solar radiation heats air in the solar collector 10. A stream of heated air moves from the solar collector 10 through the turbine of the electrical energy producing system 42 to the tunnel system 45 and up from the first elevation 46 to the second elevation 47 to at an outlet gate 49, where the stream of air is exhausted to the atmosphere.

In other embodiments the turbine and generator are placed in the tunnel system 45 or near the outlet gate 49. The outlet gate 49 can be of variable size, and controlled by an automation system, in order to prevent cold air falling into the tunnel system 45 particularly at low air flow conditions. The column of heated air in the tunnel system 45 is less dense than a similar column of cooler air in the atmosphere thereby creating a low pressure on the side of the turbine that link up to the outlet gate 49 relative to a high pressure on the side of the turbine that link up to the solar collector 2. Due to the difference in pressure, the stream of heated air is driven and/or drawn through the turbine. The partial vacuum also causes air to be drawn into the solar collector system 10 through the plurality of air intake gates 30, and further maintains the flow of heated air throughout the energy conversion system.

In alternative embodiments, means other than a sloping tunnel are used to cause air to flow through the passageways 15 of the solar collector system 10 and/or to maintain the flow of heated air throughout the energy conversion system.

The energy conversion system described above is suitable for converting solar radiation into electrical energy. When there is more solar radiation, more electrical energy is produced. The most electrical energy is usually produced during the same portion of a day as when there is the largest load on the electric grid in geographical locations where there is significant use of air conditioners. In most locations there is a need for electric energy when no solar radiation is available, such as at night. The heat accumulation system 40 is used to supply a heated stream of air when low or no solar radiation is present.

In the embodiment of FIG. 6, heat accumulation system 40 is first primed when solar radiation is present as follows. A first outlet gate 50 from the solar collector 10 may or may not be closed or partially closed by an automation system. A second outlet gate 51 from the solar collector 10 is at least partially opened by the automation system; and an outlet gate 52 from the heat accumulation system 40 is at least partially opened by the automation system. The above-described pressure difference causes the stream of air heated in the solar collector 10 to flow through the heat accumulation system 40 to thereby heat the heat transfer medium of the heat accumulation system 40.

After the heat accumulation system 18 is primed and when solar radiation is no longer present, the first outlet gate 50 from the solar collector system 10 may or may not be closed or partially closed in order to supply a desired rate of air flow rate to the tunnel system 45. The second outlet gate 51 from the solar collector system 10 is at least partially opened; and the outlet gate 52 from the heat accumulation system 40 is at least partially opened. The above-described pressure difference causes a stream of air from the solar collector system 10 to flow through the heat accumulation system 40, and a stream of air heated by flowing past the heat transfer medium of accumulation system 40 to flow to the electrical energy producing system 42.

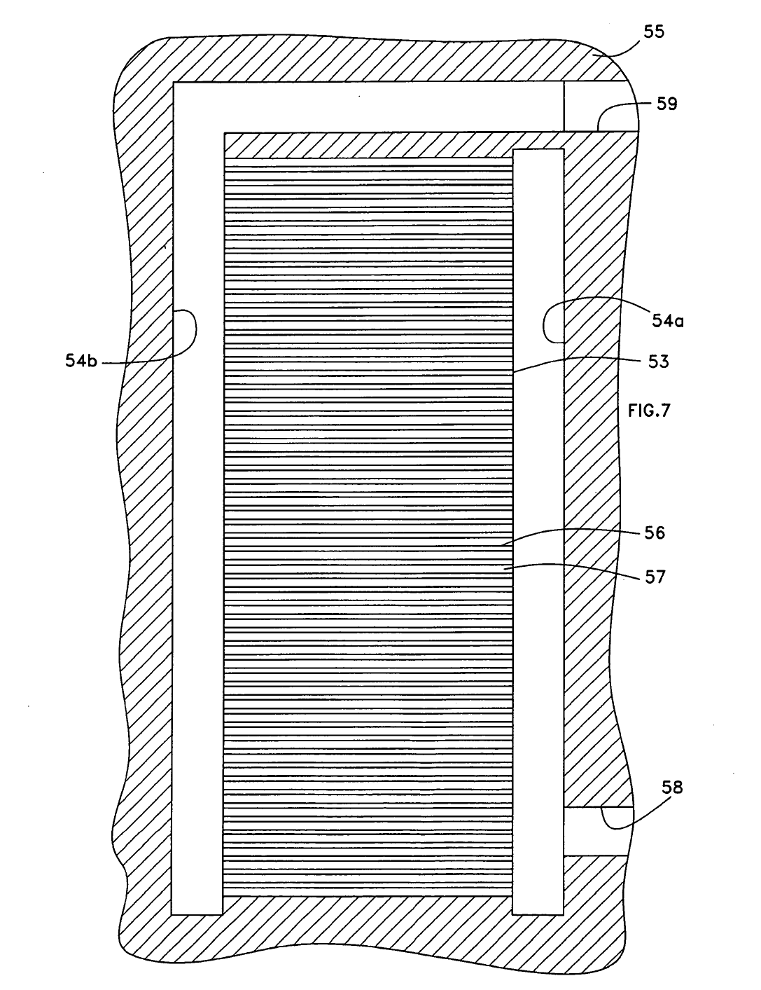

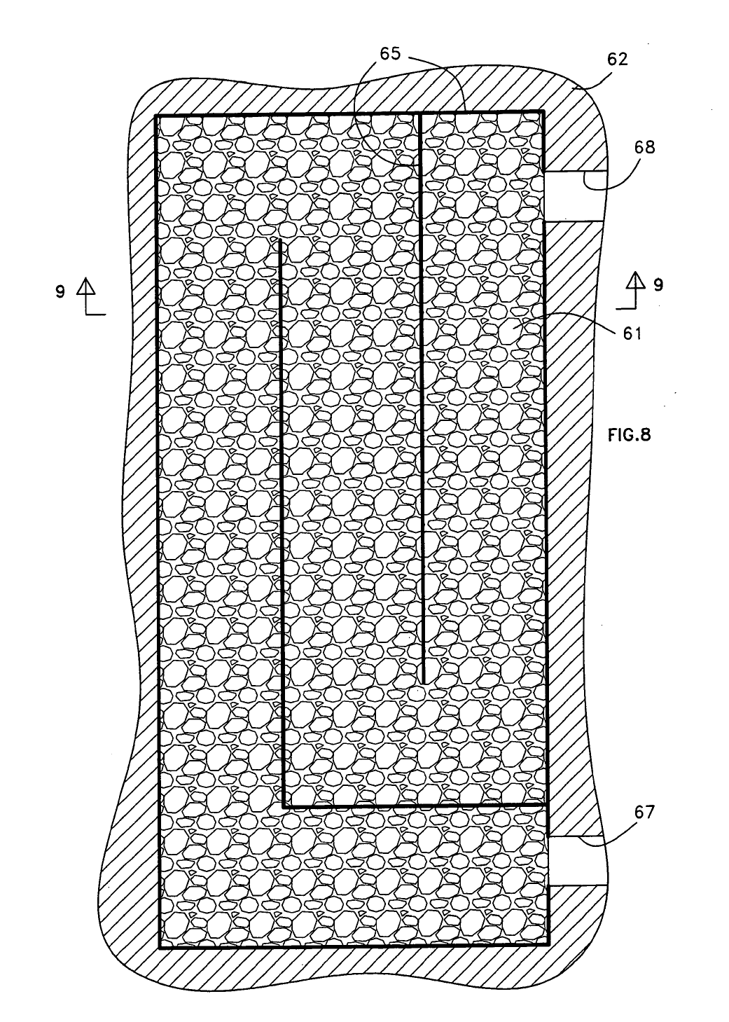

Referring to FIG. 7, in one exemplary embodiment of the heat accumulation system 40, the heat transfer medium includes walls 53 of a tunnel 54a, 54b in a terrain 55 and walls 56 of some drill-holes 57 in the walls 53 of the tunnel. Air enters a first portion 54a of the tunnel from an air inlet 58 and flows through the drills holes 57 into a second portion 54b of the tunnel to heat the walls 56 of the drills holes 57. Air flows from the second portion 55b of the tunnel via an air outlet 59.

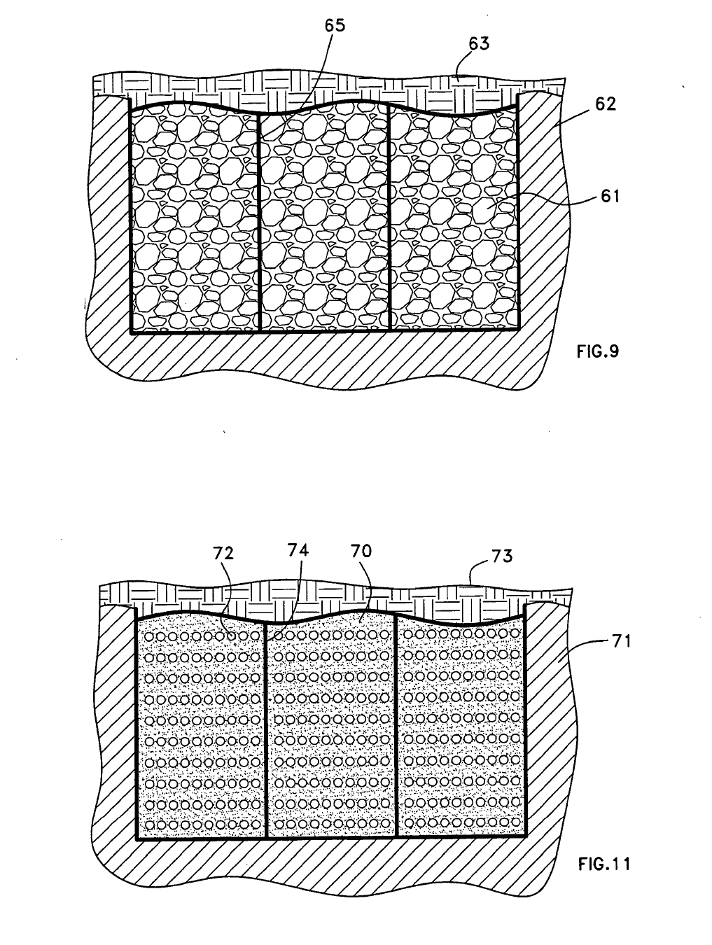

Referring to FIGS. 8 and 9, in another exemplary embodiment of the heat accumulation system 40, the heat transfer medium includes rocks 61 within a terrain 62. The rocks 61 are covered with sod 63. A passageway through the rocks 61 is defined by the barriers 65, such as sheets of plastic material. Air enters the passageway defined by the barriers 65 from an air inlet 67 and flows between the rocks 61 to heat the rocks 61. Air flows from the passageway via an air outlet 68.

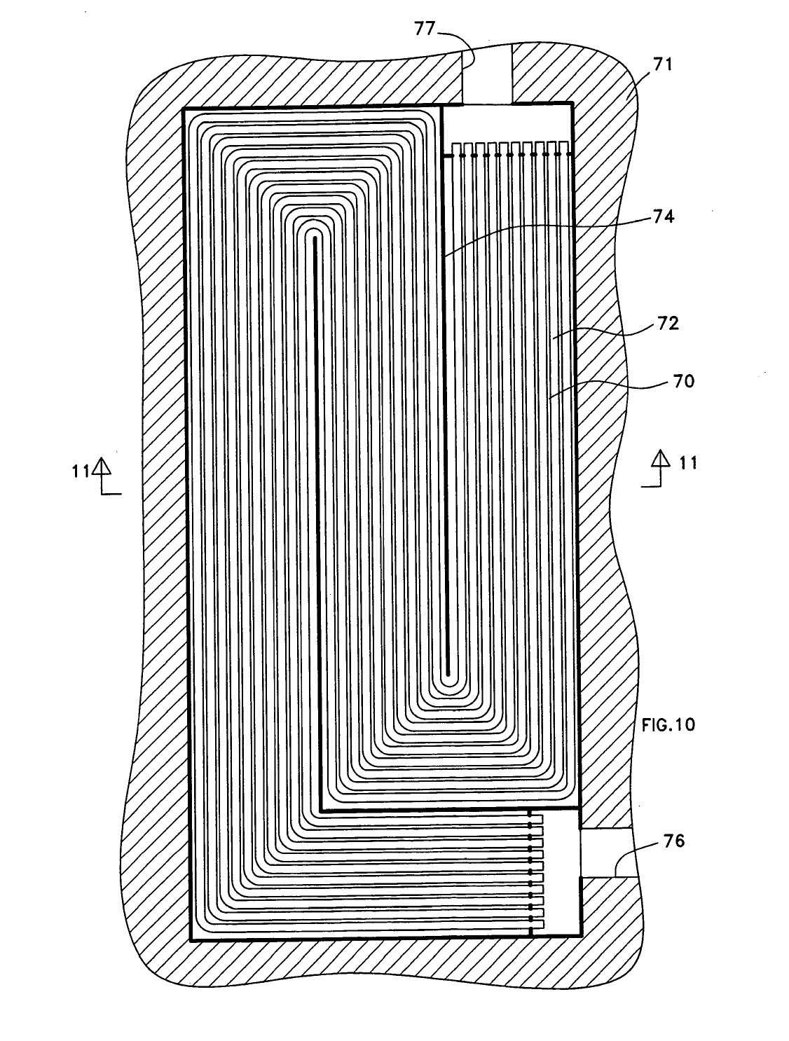

Referring to FIGS. 10 and 11, in still another exemplary embodiment of the heat accumulation system 40, the heat transfer medium includes sand and/or gravel 70 within a terrain 71 and tubes 72 having heat transmissive walls. The sand and/or gravel 70 are covered with sod 73. The tubes 72 pass through the sand and/or gravel 70 for enabling heat to be transferred between air flowing through the tubes 72 and the sand and/or gravel 70. In an exemplary embodiment, the tubes 72 are plastic drainage pipes that are not perforated. The tubes 72 are uniformly disposed within the sand and/or gravel and follow a passageway that is defined by barriers 74, such as sheets of plastic material. Air enters the tubes 72 from an air inlet 76 and flows from the tubes via an air outlet 77.

The various embodiments described herein may be combined with one another.

The benefits specifically stated herein do not necessarily apply to every conceivable embodiment of the present invention. Further, such stated benefits of the present invention are only examples and should not be construed as the only benefits of the present invention.

While the above disclosure contains many specificities that may or may not be common to all of the embodiments described herein, these specificities are not to be construed as limitations on the scope of the claimed invention, but rather as examples of the preferred embodiments described herein. For example the scope of the method claims should not be construed to cover only methods having the steps occur in the sequence recited herein. Other variations are possible and the scope of the present invention should be determined not by the embodiments described herein but rather by the claims and their legal equivalents. The claims require no implicit limitations. Each claim is to be construed explicitly as stated, or by its legal equivalent.

1. A solar collector system, comprising:
at least one sheet that is disposed to cover at least a portion of at least one channel within a terrain to thereby form an air flow passageway bounded by at least the sheet and the sides and bottom of the channel, wherein the sheet enables transmission of at least some solar radiation into the channel so that at least portions of the sides and bottom of the channel can be heated by the transmitted solar radiation so that air in the passageway can be heated by absorbing heat from at least the heated portions of the sides and bottom of the channel; and
means for enabling a stream of heated air to flow from the passageway.

2. A system according to claim 1, in combination with:
a system for producing electrical energy from at least the air heated in the passageway.

3. A system according to claim 2, wherein the electrical energy producing system includes a turbine that is coupled to an electricity generator that generates electricity when the turbine is rotated, the system further comprising:
a sloping tunnel system that is disposed inside and/or outside of a high rise of terrain for drawing the stream of heated air through the turbine.

4. A system according to claim 3, wherein a significant portion of the tunnel system leads in a direction that is non-orthogonal to vertical and horizontal.

5. A system according to claim 1, further comprising:
a gate disposed at an inlet to the passageway for controlling the flow of air into the passageway;
a gate disposed at an outlet from the passageway for controlling the flow of air from the passageway;
apparatus for measuring air pressure within the passageway; and
apparatus that is responsive to said air pressure measurements for operating one or both of the gates to control the flow of air into and/or from the passageway and thereby regulate the air pressure within the passageway.

6. A system according to claim 1, wherein the bottom and/or one or both sides of the channel includes one or more materials that absorb solar radiation as heat.

7. A system according to claim 1, wherein at least one sheet is partially supported by air pressure within the passageway.

8. A system according to claim 1, wherein the at least one sheet is flexible, further comprising:
a mesh for partially supporting the flexible sheet over the channel.

9. A system according to claim 1, wherein the at least one sheet is disposed to cover substantial portions of a plurality of channels within the terrain to thereby form a respective plurality of said air flow passageways.

10. A system according to claim 1, wherein the at least one channel is dimensioned for accommodating movement of a vehicle inside the passageway.

11. A system according to claim 1, wherein the channel substantially follows equal-elevational contours of the terrain.

12. A system according to claim 1, in combination with:
a heat accumulation system that is coupled to the passageway for accumulating heat from the heated stream of air.

13. A system according to claim 12, wherein the heat accumulation system comprises:
a heat transfer medium for accumulating heat from the heated air stream; and
means for conducting a stream of heated air from the heat transfer medium.

14. A system according to claim 13, wherein the heat transfer medium includes the walls of a tunnel.

15. A system according to claim 14, wherein the heat transfer medium further includes some drill-holes in the walls of the tunnel.

16. A system according to claim 13, wherein the heat transfer medium includes rocks.

17. A system according to claim 13, wherein the heat transfer medium includes sand and/or gravel.

18. A system according to claim 17, wherein the heat accumulation system includes tubes having heat transmissive walls passing through the sand and/or gravel for enabling heat to be transferred between air flowing through the tubes and the sand and/or gravel.

19. A heat accumulation system for accumulating heat from a heated stream of air from a solar collector, comprising:
a heat transfer medium for accumulating heat from the heated air stream; and
means for conducting a stream of heated air from the heat transfer medium.

20. A system according to claim 19, wherein the heat transfer medium includes the walls of a tunnel.

21. A system according to claim 20, wherein the walls of the tunnel include some drill-holes.

22. A system according to claim 19, wherein the heat transfer medium includes rocks.

23. A system according to claim 19, wherein the heat transfer medium includes sand and/or gravel.

24. A system according to claim 23, wherein the heat accumulation system includes tubes having heat transmissive walls passing through the sand and/or gravel for enabling heat to be transferred between air flowing through the tubes and the sand and/or gravel.

25. A method of constructing a solar collector system, comprising the steps of:
(a) constructing at least one channel within a terrain;
(b) covering at least a portion of the at least one channel with at least one sheet to form an air flow passageway bounded by at least the sheet and the sides and bottom of the channel, wherein the sheet enables transmission of at least some solar radiation into the channel so that at least portions of the sides and bottom of the channel can be heated by the transmitted solar radiation so that air in the passageway can be heated by absorbing heat from the heated portions of the sides and bottom of the channel; and
(c) coupling to the passageway to means for enabling a stream of heated air to flow from the passageway.

26. A method according to claim 24, further comprising the steps of:
(d) disposing a gate at an inlet to the passageway for controlling the flow of air into the passageway;
(e) disposing a gate at an outlet from the passageway for controlling the flow of air from the passageway;
(f) providing apparatus for measuring air pressure within the passageway; and
(g) providing apparatus that is responsive to said air pressure measurements for operating one or both of the gates to control the flow of air into or from the passageway and thereby regulate the air pressure within the passageway.

27. A method according to claim 25, further comprising the step of:
(d) including a substantial quantity of one or more materials that absorb solar radiation as heat in the bottom and/or one or both sides of the channel.

28. A method according to claim 25, further comprising the step of:
(d) dimensioning the at least one channel for accommodating movement of a vehicle through the passageway.

29. A method according to claim 25, wherein step (a) comprises the step of:
(d) constructing the channel to substantially follow equal-elevational contours of the terrain.

30. A method of deriving energy from solar radiation, comprising the steps of:
(a) enabling solar radiation to be transmitted through at least one sheet into an air flow passageway bounded by the sheet and at least one channel within a terrain, wherein at least a portion of the channel is covered by the at least one sheet so that at least portions of the sides and bottom of the channel can be heated by the transmitted solar radiation so that air in the passageway can be heated by absorbing heat from the heated portions of the sides and bottom of the channel; and
(b) enabling air to flow through the passageway and thereby be heated by absorbing heat from heated portions of the sides and bottom of the channel; and
(c) enabling a stream of heated air to flow from the passageway.

31. A method according to claim 30, further comprising the step of:
(d) producing electrical energy from a stream of heated air flowing from the passageway.

32. A method according to claim 30, further comprising the step of:
(d) accumulating heat from the heated stream of air in a heat transfer medium.

33. A method according to claim 32, further comprising the step of:
(e) enabling a stream of heated air to flow from the heat transfer medium.

34. A method according to claim 33, further comprising the step of:
(f) producing electrical energy from a stream of heated air flowing from the heat transfer medium.

35. A method according to claim 30, further comprising the steps of:
(d) making measurement of the air pressure within the passageway; and
(e) in response to said air pressure measurements, operating a gate disposed at an inlet to the passageway and/or a gate disposed at an outlet from the passageway to control the flow of air into or from the passageway and thereby regulate the air pressure within the passageway.

36. A method of utilizing a sloping tunnel to facilitate conversion of solar radiation to electrical energy, comprising the steps of:
(a) heating a stream of air with a solar collector;
(b) conducting the stream of heated air to a turbine that is coupled to an electricity generator in an electrical energy producing system for generating electricity when the turbine is rotated; and
(c) conducting the stream of heated air through the turbine with a sloping tunnel system that is disposed inside and/or outside of a high rise of terrain and extends from a first elevation to a second elevation that is of a higher elevation than the first elevation, to thereby rotate the turbine and cause electricity to be generated;
wherein a significant portion of the tunnel system leads in a direction that is non-orthogonal to vertical and horizontal.
